(19) United States
(12) Patent Application Publication
(10) Pub. No.: US 2011/0280187 A1
(43) Pub. Date: Nov. 17, 2011

(54) Provision of an end-to-end connection from a terminal unit to a network

(75) Inventor: Ullrich Meyer, Pfungstadt (DE)

(73) Assignee: Vodafone Holding GmbH, Dusseldorf (DE)

(21) Appl. No.: 13/104,379

(22) Filed: May 10, 2011

(30) Foreign Application Priority Data
May 12, 2010 (DE) 102010028974.4-31

(51) Int. Cl. H04W 4/00

(52) U.S. Cl. 370/328

(57) ABSTRACT

There is provided a method for providing at least one packet-oriented end-to-end connection from a terminal unit to another network via at least one connection in a mobile telecommunications network. A set-up of the connection includes an assignment of an address for addressing data packets to the terminal unit. The method comprises transferring, via a modem that is connected to the mobile telecommunications network via an air interface, the address to the terminal unit. The method also comprises forwarding data packets of the end-to-end connection that have been received from the mobile telecommunications network to the terminal unit, the data packets being forwarded in an association with the connection.

### CROSS-REFERENCE TO RELATED APPLICATION

This application claims priority to German (DE) Patent Application No. 10 2010 028 974.4-31, filed on May 12, 2010, the contents of which are incorporated by reference as if set forth in their entirety herein.

### BACKGROUND

Mobile telecommunications networks normally comprise a core network and an access network that is connected to the core network, the access network containing the radio transmission technology and accessing the core network via the terminal devices. The core network can be connected to a further network that is configured as a communication or data network such as, for instance, the Internet, and/or it can be connected to a further network of a telecommunications service provider encompassing network units that provide certain services of the mobile telecommunications network such as, for example, a Voice over IP (VoIP) service.

For purposes of packet-oriented data transmission, a so-called virtual or logical connection is normally established between a terminal device and a network unit of the core network so that data packets can be exchanged between the network and the terminal device. Usually, the transmission path is based on the Internet Protocol (IP) and entails the assignment of an address, especially an IP address, to the terminal device, so that data packets in the core network or in the connected networks can be addressed to the terminal device.

This logical connection is linked via the network unit of the core network to connections into the networks that are connected to the core network. In this manner, end-to-end connections can be established between the terminal device and network units in the networks that are connected to the core network. The logical connection is configured as a bearer connection (bearer) for the end-to-end connection and, usually, it is, in turn, made up of several individual bearers connecting individual network units in the core network and in the access network.

FIG. 1 shows a schematic depiction of an appertaining hierarchical connection model for the mobile telecommunications network according to the LTE/SAE specifications of the 3rd Generation Partnership Project (3GPP), which is also referred to as a mobile telecommunications network of the 4th generation (4G-network) (LTE: Long-Term Evolution; SAE: System Architecture Evolution).

As the figure shows, a terminal device 101 in such a network is connected via the air interface 102 to an access point 103—designated as eNodeB (eNB)—of the LTE access network 104. The access point 103 is connected via an interface 105, which is designated as the 51 interface, to a gateway system of the core network 106, which is configured as an SAE gateway. The latter comprises an input gateway unit 107, namely, the serving gateway (S-GW), and an output gateway 108, namely, the packet data network gateway (P-GW). The two gateway units 107, 108 are connected to each other via the S5/S8 interface 109. The output gateway unit 108 connects the core network 106 via one or more interfaces to one or more external networks 110 which provide applications or services that can be accessed by means of the terminal device 101, an example of which is shown as one network 106 in FIG. 1.

Via the above-mentioned interfaces, connections are established between each of the individual network units that are associated with the bottom hierarchical layer. This hierarchical layer comprises the radio connection (radio bearer) 112 established via the air interface 102 between the terminal device 101 and the access point 103. Moreover, the bottom layer comprises the 51 connection (51 bearer) 113 between the access point 103 and the input gateway unit 107 as well as the S5/S8 connection (S5/S8 bearer) 114 between the input gateway unit 107 and the output gateway unit 108.

On a second hierarchical level, the logical connection 116 from the terminal device 101 to the core network 106 is established between the terminal device 101 and the output gateway unit 108 via the above-mentioned connections. The logical connection 116 is also referred to as the EPS bearer and is especially characterized by the assignment of an IP address to the terminal device 101 and by a certain quality of service (QoS). The quality of service is ensured by all of the connections 112, 113, 114 of the bottom layer, which are linked to each other in order to establish the logical connection 116. Furthermore, the second level comprises an IP-based connection (external bearer) 117 between the core network 106 or the output gateway unit 108 and a unit 118 in the external network 110.

With the use of the connections 116, 117 of the second level, the end-to-end connection 120 is provided in the third level, and this connection 120 makes it possible to exchange data between the terminal device 101 and the unit 118 in the external network 110.

In the model, the radio connection 112, whose establishment calls for a device containing the requisite radio technology, as well as the logical connection 116 of the second layer and the end-to-end connection 120 terminate in the terminal device 101. In order to allow applications to communicate with a unit 118 in the external network 110 via the end-to-end connection 120, the terminal device 101 provides proprietary functions that operate on the third layer of the previously explained layer model. Standardized interfaces for the (external) access to the end-to-end connection 120 are, however, not provided.

As a result, this especially entails the drawback that additional external devices that are connected to the terminal device 101 containing the radio technology, or applications executed in these devices, cannot readily access the end-to-end connection 120. For this purpose, either a (non-standardized) direct interface has to be created between the external device and the terminal device 101, or else the terminal device 101 would have to be integrated along with the additional device into another network in which the terminal device 101 provides functions for accessing the end-to-end connection 120.

In the latter case, an additional dedicated IP address would be assigned to the additional device, and either the terminal device 101 would have to incorporate the data packets of the third layer—which are transmitted via the end-to-end connection 120—into additional data packets that are then sent, or else the terminal device 101 would have to replace the IP address of the additional device in the data packets with its own address in order to forward the data packets. The reason for this is that the mobile telecommunications network only transmits data packets to the IP address that it has assigned to the terminal device 101. Incoming data packets for the additional device would be correspondingly taken from additional data packets addressed to the terminal device 101, or would be addressed with the IP address of the terminal device 101, which would have to replace this address with the IP address of the additional device.

The creation of a direct interface for accessing the end-to-end data connection 120 as well as the set-up of another network with the terminal device 101 and with the additional device involve a great expenditure of resources. Moreover, the latter solution—especially if additional IP data packets are used for receiving the data packets exchanged between the additional device and the external network—would lead to an increase in data in the IP data packets transmitted via the mobile telecommunications network. Another drawback is that existing functions of the additional device for accessing an IP-based end-to-end data connection 120 are not used when the direct interface is created or else these functions would have to be additionally implemented in the terminal device 101 when another network is set up.

### SUMMARY

Therefore, the subject innovation relates to simplifying the access to an end-to-end data connection that is established via a logical connection in a mobile telecommunications network for devices that do not directly access the air interface of the mobile telecommunications network.

According to a first aspect of the subject innovation, a method is suggested in which a modem that is connected to the mobile telecommunications network via an air interface transfers the address to the terminal unit and forwards data packets of the end-to-end connection that have been received from the mobile telecommunications network to the terminal unit, the data packets being forwarded in an association with the connection.

According to another aspect of the subject innovation, a device is proposed that can be connected to the mobile telecommunications network via an air interface and that is configured to transfer the address to the terminal unit and to forward data packets of the end-to-end connection that have been received from the mobile telecommunications network to the terminal unit, the data packets being forwarded in an association with the connection.

The connection created in the mobile telecommunications network is especially configured as a bearer connection (bearer) by means of which the end-to-end connection is established. The bearer connection can, in turn, be made up of individual linked bearer connections.

The subject innovation relates to the provision of an end-to-end connection between a terminal unit and a network. In particular, the subject innovation relates to a method and to a device that is suitable for carrying out the method for the provision of at least one packet-oriented end-to-end connection from a terminal unit to another network via at least one connection in a mobile telecommunications network, a set-up of the connection including the assignment of an address for addressing data packets to the terminal unit.

The subject innovation comprises the idea of making the end-to-end connection via the modem to the terminal unit so that the end-to-end connection does not terminate in the modem but rather in the terminal unit. This is achieved particularly in that the address assigned by the mobile telecommunications network is forwarded from the modem to the terminal unit. The modem itself, however, does not have an address assigned to it that is used for addressing the modem. The modem functions preferably transparently on the level of the packet data protocol being employed. In this process, the modem can particularly forward the data packets in unchanged form. In one embodiment, the packet data protocol employed is the IP and the address that is used for addressing data packets is an IP address.

In order to make it possible to transmit data packets to the additional network via the end-to-end connection, one embodiment of the method and of the device provides that the modem receives data packets sent from the terminal unit in an association with the connection is made and forwards them via the connection. Due to the association with the connection, the modem preferably ascertains the connection via which the data packets are forwarded to the mobile telecommunications network.

One embodiment of the method and of the device provides that the data packets are associated with the connection using an identifier that is linked to the data packets and that is stored in the modem in an association with the connection. Advantageously, a logical connection associated with the connection in the mobile telecommunications network can be established via the connection between the modem and the terminal unit in this manner. In particular, a Virtual Local Area Network (VLAN) connection can be established in order to transmit the data packets between the modem and the terminal device. Here, the identifier corresponds to a so-called VLAN-ID.

The identifier is preferably not incorporated into the data packets, and the data packets are preferably not changed by the modem in any other way in order to associate the identifier. Consequently, functions for processing the data packets do not have to be implemented in the modem. In one embodiment of the method and of the device, it is provided that the data packets are transmitted in connection-specific data frames of a local connection between the modem and the terminal device and the data frames are provided with the identifier. The connection-specific protocol for the transmission of data between the modem and the terminal device can be, in particular, the Ethernet protocol. Accordingly, the connection-specific frames are configured as Ethernet frames and, in the above-mentioned embodiment, are especially configured as so-called tagged Ethernet frames.

The subject innovation makes it possible to provide several end-to-end connections to one or more additional networks via different connections within the mobile telecommunications network. One embodiment of the method and of the device is characterized in that an unambiguous identifier is associated with each of the connections. Advantageously, the identifiers make it possible to associate data packets to the different connections within the modem and/or within the terminal unit.

In an embodiment of the method and of the device, a first end-to-end connection is established for data transmission to a first additional network configured as a data network, particularly the Internet. A second end-to-end connection is established for speech transmission to a voice over IP server in a second additional network. Thus, the modem particularly makes it possible to provide a data service for access to the Internet as well as an IP-based service for voice calls via the mobile telecommunications network, and the services can be accessed in a dedicated and prioritized manner by means of a terminal unit that is separate from the modem.

In another embodiment of the method and of the device, signaling messages are exchanged between the modem and the terminal device via the local connection using an associated identifier. On the basis of such signaling messages, for example, the IP address can be transferred to the terminal unit. It is likewise possible for the terminal unit to control the modem.

Preferably, however, the terminal unit does not carry out the exchange of signaling data with the mobile telecommunications network. The modem is preferably provided for this purpose so that, in particular, the functions or protocols for the exchange of signaling data do not need to be implemented in the terminal unit. Therefore, one embodiment of the method and of the device provides that signaling data, especially signaling data for registering with the mobile telecommunications network and/or for establishing the connection, are exchanged between the modem and the mobile telecommunications network, signaling messages sent to the network being generated in the modem.

Furthermore, according to another aspect, the subject innovation proposes a system that comprises a device of the type described herein and the terminal unit. One embodiment of the system is characterized in that a first end-to-end connection is established for data transmission from the terminal unit to a first additional network configured as a data network, particularly the Internet, and a second end-to-end connection for speech transmission from the terminal unit to a voice over IP server in a second additional network. In another embodiment, the terminal unit can be connected to at least one user terminal device and it is configured so that the user terminal device can access the first and/or the second end-to-end connection.

### BRIEF DESCRIPTION OF THE DRAWINGS

The above-mentioned and additional advantages, special features and practical refinements of the subject innovation are also elucidated on the basis of the embodiments which will be described below, making reference to the figures.

The figures show the following:

FIG. 1 is a diagram of a layer model for setting up an end-to-end data transmission service between a terminal device and an external network connected to the mobile telecommunications network according to the state of the art;

FIG. 2 is a block diagram showing a mobile telecommunications network and a modem according to the subject innovation as well as a terminal device connected to it;

FIG. 3 is a diagram of a layer model for setting up a data transmission path between the terminal device and the external network that is connected to the mobile telecommunications network; and

FIG. 4 is a diagram of a terminal device that is connected to two external networks via a mobile telecommunications network.

### DESCRIPTION OF SPECIFIC EMBODIMENTS

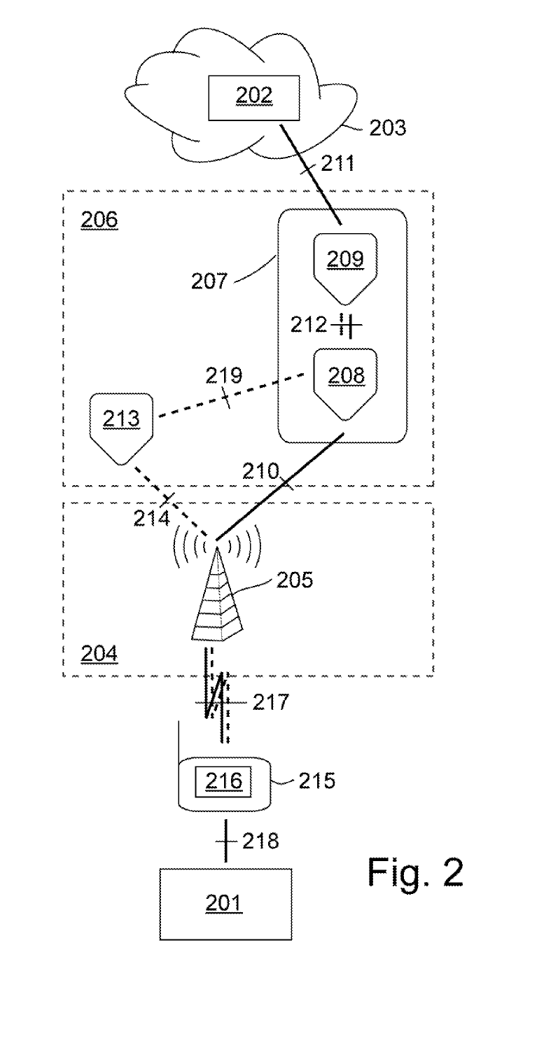

FIG. 2 shows a schematic representation of selected components of a mobile telecommunications system which comprises an LTE/SAE network in the depicted embodiment, and through which a terminal unit 201 is connected to a server unit 202 in an external network 203. The external network is configured as a communication and/or data network, and is preferably based on the IP. The server unit 202, for example, provides one or more web pages that can be accessed by the terminal unit 201 or else it provides an IP-based service which a user can access via the terminal unit 201. The terminal unit 201 is, for example, an Internet-capable computer. By the same token, however, the terminal unit 201 can also be connected to additional devices that communicate with the server unit 202 via the terminal unit 201. In this case, the additional devices in a private network, for example, a home or company network that is separated from the mobile telecommunications network, are connected to the terminal unit 201.

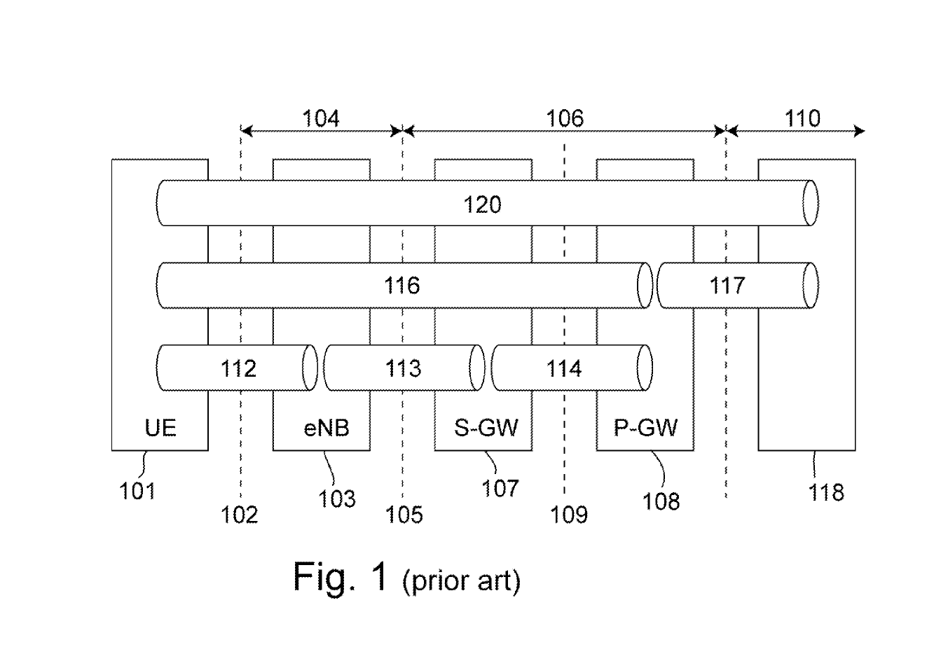

The mobile telecommunications network comprises a radio-based cellular access network 204 in which for each radio cell one access point 205 makes it possible to wirelessly access the mobile telecommunications network via an air interface 217. The access points 205, only one of which is shown in FIG. 1, are connected to the core network 206 of the mobile telecommunications network and configured in one embodiment as eNBs.

The core network 206 comprises a gateway system 207 which, in the embodiment shown, has two gateway units 208, 209. An input gateway unit 208 is connected to several access points 205 of the access network 204 via an interface 210, and an output gateway unit 209 is connected to the external network 203 via another interface 211. The input gateway unit 208 is configured as a serving gateway (S-GW) and is connected to the access points 205 via the S1-U interface 210. In the embodiment shown, the output gateway unit 209 is a packet data network gateway (P-GW) that is connected to the external network 203 via an SGi interface 211. Between the gateway units 208, 209, there is an interface 212 that is configured as an S5/S8 interface. Via the gateway system 207 and the above-mentioned interfaces 210, 211, 212, the data transmission path is set up for the transmission of user data to terminal devices that are connected to the access network 204. The user data transmission is shown in FIG. 1 using solid lines.

The connection between the terminal devices and the mobile telecommunications network is controlled by a control unit 213 that is configured as a Mobility Management Entity (MME). The control unit 213 is connected to several access points 205 via an interface 214 that is configured as an S1-MME interface, and it is connected to the gateway system 207, especially to the input gateway unit 208, via an interface 219 that is configured as an S11 interface. Signaling data for controlling the connection is transmitted via the above-mentioned interfaces, as is shown in FIG. 1 with broken lines. Signaling data can likewise be exchanged between the input gateway unit 208 and the output gateway unit 209 via the interface 219.

The terminal device 201 is connected to the mobile telecommunications network via a modem 215. The modem has a radio module 216 with which a connection can be established to an access point 205 of the access network 204 via the air interface 217. There is a local interface 218 between the modem 215 and the terminal device 201. In one embodiment, the local interface 218 is configured as a hard-wired interface, especially as an Ethernet interface. Likewise, however, it can also be provided that the interface 218 is configured in a different manner and, for instance, is implemented as a different hard-wired interface or as a wireless interface, for example, as a Bluetooth interface.

For establishing a connection between the terminal unit 201 and the server unit 202 the modem 215 registers with the mobile telecommunications network, at first. This can be done, for example, in response to a request that is sent in a signaling message from the terminal unit 201 to the modem 215, or else when the modem 215 is switched on. In order to perform the registration procedure (attach procedure), data is exchanged between the modem 215 and the control unit 213 of the network, and the data exchange can especially take place on the basis of the NAS (Non-Access Stratum) protocol. The registration procedure can especially comprise an authentication. For this purpose, data is used in a manner familiar to the person skilled in the art, said data being stored in a subscriber identification module, particularly a Universal Subscriber Identification Module (USIM), contained in a chip card that is inserted into the modem 215. The terminal device 201 is preferably not involved in the execution of the registration procedure and therefore, it does not have to implement the appertaining protocols.

The end-to-end connection 305 is established between the terminal unit 201 and the server unit 202 in conjunction with the registration procedure or in response to a separate request that is sent from the modem 215 to the control unit 213. The separate request can, in turn, be triggered by an appertaining signaling message that is sent from the terminal unit 201 to the modem 215. The transmission of the request and the subsequent communication with the control unit 213 for purposes of configuring the connection, in turn, is only carried out between the control unit 213 and the modem 215, without the involvement of the terminal unit 201, so that the latter does not have to have the appertaining protocols.

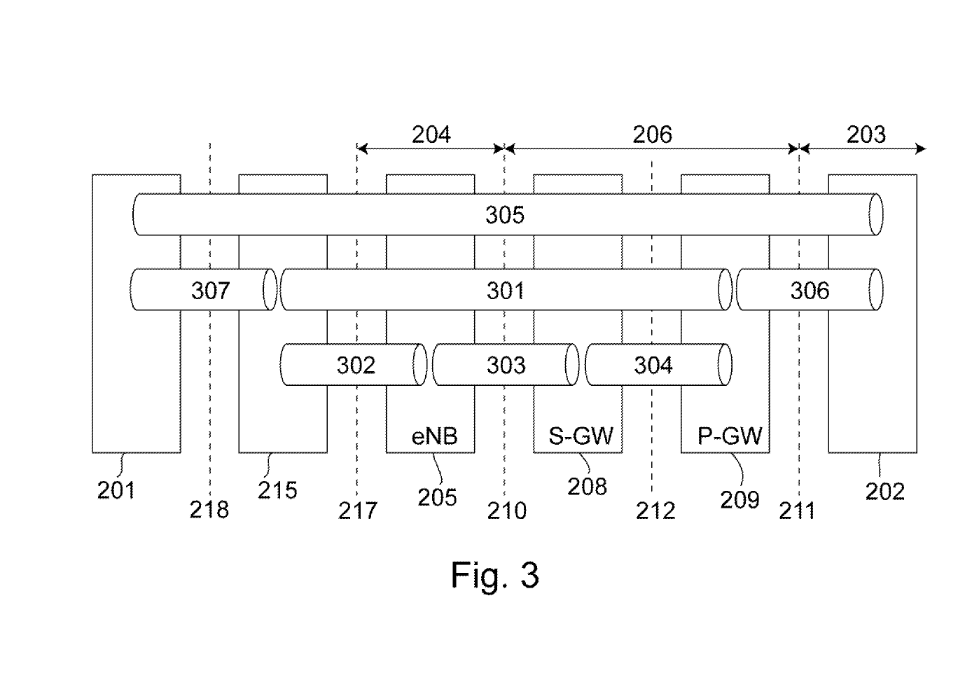

In order to establish the end-to-end connection 305, a logical connection 301 is established between the output gateway unit 209 and the modem 215. The connection 301, which is referred to as EPS bearer as already explained above, results from a linking of individual connections 302, 303, 304 between the involved units 205, 207, 208 of the mobile telecommunications network and of the modem 215, as is schematically depicted in FIG. 3. In the mobile telecommunications network depicted in FIG. 2, these connections are the radio connection 302 between the modem 215 and the pertinent access point 205, an Si connection 303 between the access point 205 and the associated input gateway unit 208, and an S5/S8 connection 304 between the input gateway unit 208 and the output gateway unit 209. Usually, the individual connections 302, 303, 304 and the logical connection 301 are established together.

Via the logical connection 301, the end-to-end connection 305 is established between the terminal unit 201 and the server unit 202 on the basis of the IP, that means, data packets, especially IP data packets, are transmitted from the terminal unit 201 to the server unit 202 and vice versa. Within the individual connections 302, 303, 304 between the network units 205, 207, 208, the data packets are transmitted via different communication protocols. These are protocols of layer 1 (physical layer) and of layer 2 (security layer) of the OSI reference model, which are generally known to the person skilled in the art. Between the output gateway unit 209 and the server unit 202, the data exchange takes place within the end-to-end connection 305 via an IP-based connection 306, which is also referred to as an external bearer and which is as such likewise familiar to the person skilled in the art.

On the network side, the logical connection 301 is associated with a certain quality of service (QoS). In this manner, for example, maximum and minimum or guaranteed bit rates are defined for the data transmission via the logical connection 301 and so is a priority that the logical connection 301 should have relative to other connections when there is a large volume of connections. The quality of service can be specified in the request of the data connection from the modem 215. In one embodiment, it is provided that the terminal device 201 selects the desired or required quality of service and reports it to the modem 215. This can be done, for example, in the signaling message with which the terminal device 201 instructs the modem 215 to request the establishment of the connection. Likewise, however, it can also be provided that the quality of service is prescribed on the network side.

Moreover, an IP address is assigned to the logical connection 301 when it is established and this IP address is used to address data packets to the modem 215 or to the terminal device 201. This address is reported to the modem 215 when the logical connection 301 is established. However, the modem 215 forwards the received IP address to the terminal unit 201, which includes the IP address into its IP configuration. This also means that the terminal device 201 makes transmissions to the server unit 202, indicating this IP address. However, the modem 215 is not assigned an IP address of its own. As a result, the end-to-end connection 305 to the server unit 202 is not terminated in the modem 215, but rather in the terminal unit 201.

In one embodiment, the IP address is transferred to the terminal unit 201 by a DHCP server that is contained in the modem 215 (DHCP: Dynamic Host Configuration Protocol). In the terminal unit 201, the IP configuration is made by a DHCP client that receives the IP address from the DHCP server of the modem 215. In addition to the IP address, the modem 215 and, in particular the contained DHCP server, transfer additional parameters that are associated with the logical connection 301 to the terminal unit 201 such as, for instance, the so-called default gateway and/or the address of the Domain Name Server (DNS) that is to be used.

The data exchange takes place via a local connection 307 that is implemented via the local interface 218 between the modem 215 and the terminal unit 201. The signaling messages as well as the IP data packets of the end-to-end connection 305 are sent via this connection. All in all, this yields the diagram shown in FIG. 3 in which the familiar connection architecture of the mobile telecommunications network is augmented by the local connection 307 between the modem 215 and the terminal device 201.

In one embodiment, the local connection 307 is implemented by a so-called Virtual Local Area Network (VLAN). In this embodiment, the data packets associated with the end-to-end connection 305 are provided with an unambiguous identifier in the connection-specific frames of the local connection 307. Therefore, when an Ethernet interface is used, Ethernet frames provided with the identifier (Tagged Ethernet Frames) are used for the data exchange between the modem 215 and the terminal unit 201.

In the same manner, signaling messages can be sent from the terminal unit 201 to the modem 215 and vice versa. For the transmission of the signaling messages, connection-specific frames are used that are provided with a uniform identifier that differs from the identifier of the frames with data packets of the end-to-end connection 305.

A table with associations for the employed identifiers is stored in the modem 215, and these identifiers will also be referred to as VLAN-IDs below. The VLAN-ID that is associated with the end-to-end connection 305 to the server unit 202 is associated with the logical connection 301 on the basis of the table. The mobile telecommunications network issues identification codes that can be used to identify the logical connection 301. The association between the VLAN-ID and the logical connection 301 can be generated by the modem and stored in the table when the logical connection 301 is established. An additional association in the table identifies the signaling messages on the basis of their VLAN-ID.

A table is stored in the terminal unit 201, and this table makes it possible for data that is received in the frames that are specific for the local connection 307 to be associated with the end-to-end connection or to be identified as signaling messages. The end-to-end connection 305 can be identified in the terminal unit 201, for example, on the basis of the IP address received by the modem 215, and this IP address can be assigned to the corresponding VLAN-ID. The table is also used by the terminal unit 201 for sending data. If these are data packets of the end-to-end connection 305 that are to be transmitted to the server unit 202, then they are sent to the modem 215 in frames that are provided with the VLAN-ID that belongs to this connection and that can be ascertained on the basis of the table. Accordingly, signaling messages are sent in frames from the terminal unit 201 to the modem 215, and these frames are provided with the VLAN-ID that is associated with the signaling messages.

If the modem 215 receives a data packet sent by the server unit 202 via the logical connection 301, the modem first identifies the logical connection 301. Then the modem 215 determines the VLAN-ID associated with the logical connection 301 and transmits the data packet to the terminal unit 201 in a connection-specific frame that is provided with the VLAN-ID. On the basis of the VLAN-ID, the terminal unit 201 associates the data packet with the end-to-end connection 305 to the server unit 202 and processes the data packet accordingly.

Analogously, the modem 215 can send a signaling message in a connection-specific frame to the terminal device 201, and this frame is provided with the VLAN-ID that is associated with the signaling messages. On the basis of this VLAN-ID, the terminal device 201 recognizes that this is a signaling message and the terminal device 201 forwards the signaling message so that it can be appropriately processed.

When the modem 215 receives a frame from the terminal unit 201 via the local connection 307, then it first compares the received VLAN-ID to the table stored in the modem 215. If this is the VLAN-ID that is associated with the signaling messages, then the modem 215 treats the content of the frame as a signaling message. These signaling messages are preferably not forwarded to the mobile telecommunications network, but rather cause the calling up of functions of the modem 215. In particular, the terminal device 201 can thus achieve that the modem 215 sends certain requests to the mobile telecommunications network as already described above by way of example in conjunction with the request for establishing a data connection to the external network 203 and in conjunction with the request for a certain quality of service of the connection.

If the VLAN-ID is the one that is associated with the logical connection 301, then the modem 215 transfers the data packet contained in the frame to the logical connection 301 or to the radio connection 302. The data packet is transmitted via the radio connection 302 using the protocols that are provided for this connection and that are also implemented in the modem 215. However, the terminal unit 105 does not need these protocols in order to be able to transmit data via the mobile telecommunications network.

As can be seen from the preceding explanation of the mode of operation of the modem 215, IP data packets are merely forwarded by the modem 215 without being changed. It is likewise not necessary for the modem to incorporate the IP data packets received from the terminal unit 201 into additional IP packets in order to send them via the mobile telecommunications network. Consequently, the modem 215 does not operate on the level of the IP protocol, but rather on the levels below it, especially on the physical layer and on the security layer. As a result, the modem 215 can be implemented more simply and the so-called IP overhead, that is the data volume of IP packets that occur in addition to the user data, can be reduced.

Furthermore, in the manner described above, several end-to-end connections 305 that are established via different logical connections 301 can be terminated via the modem 215 in the terminal device 201. The establishment of several logical connections 301 via the mobile telecommunications network especially makes it possible to simultaneously establish end-to-end connections 305 into different external networks 203 that are connected to the core network 206. Here, a logical connection 301 to the output gateway unit 209 and an appertaining IP-based connection 306 to the external network 203 is associated with each end-to-end connection 305 to an external network 203. Likewise, several end-to-end connections 305 to the same external network 203 can be established via different logical connections 301.

When several logical connections 301 are established, the modem 215 transfers the appertaining IP addresses to the terminal unit 201 that were assigned by the mobile telecommunications network in the manner described above. In this manner, several end-to-end connections 305 between the terminal unit 201 and the server units 202 are established to one or more external networks 203 that can be used to exchange data with the server units 202. The modem 215 associates an unambiguous VLAN-ID with each of the individual logical connections 301, and this VLAN-ID, in an association with the logical connection 301, is stored in the table that is stored in the modem 215, as described above. Likewise, associations of the VLAN-IDs with the appertaining end-to-end connections 305 are stored in the terminal unit 201.

When the modem 215 receives data packets via a logical connection 301, it forwards them to the terminal unit 201 using the VLAN-ID associated with this logical connection, in the manner already described above. On the basis of the employed VLAN-ID, the terminal unit 201 can identify the appertaining end-to-end connection 305. In order to transmit data packets via one of the end-to-end connections 305 to the appropriate external network 203 or to a server unit 202, the terminal unit sends the data packets to the modem 215 using the appertaining VLAN-ID. On the basis of the VLAN-ID, the modem 215 accesses the table in order to identify the logical connection 301 and forwards the data packets via the ascertained logical connection 301.

The different logical connections 301 can be associated with different qualities of service. In particular, this can be due to different application purposes. Thus, for example, a higher quality of service can be associated with a logical connection 301 via which a VoIP connection is established to a server unit 202 in an external network 203 for purposes of speech transmission than the quality of service that is associated with a data connection to an external network 203 such as, for instance, the Internet. This can result from the fact that the requirements of the connection quality and the interruption-free availability are generally higher for speech connections than for data connections.

In order to also take into account the qualities of service or the underlying requirements in conjunction with the transmission of data packets between the modem 215 and the terminal unit, it is provided in one embodiment that different priorities are defined for the transmission of data packets of the individual end-to-end connections 305. In case of collisions, data packets having a higher priority are transmitted via the local connection 307 before data packets having a lower priority. Moreover, the modem 215 forwards data packets that are associated with a higher priority from the local connection 307 to the logical connection 301 before data packets having a lower priority, and vice versa.

The priority is preferably indicated in the connection-specific frames of the local connection 307. This takes place in one embodiment using priority bits that (in addition to the VLAN-ID) are incorporated into the frames. On the basis of the priority information in the frames, their recipients can ascertain the priority with which the data packets contained in the frames should be forwarded. In particular, the modem 215 forwards data packets that are received from the terminal unit 201 in frames with an indication of a higher priority before data packets to the appertaining local connection, which are received with an indication of a lower priority.

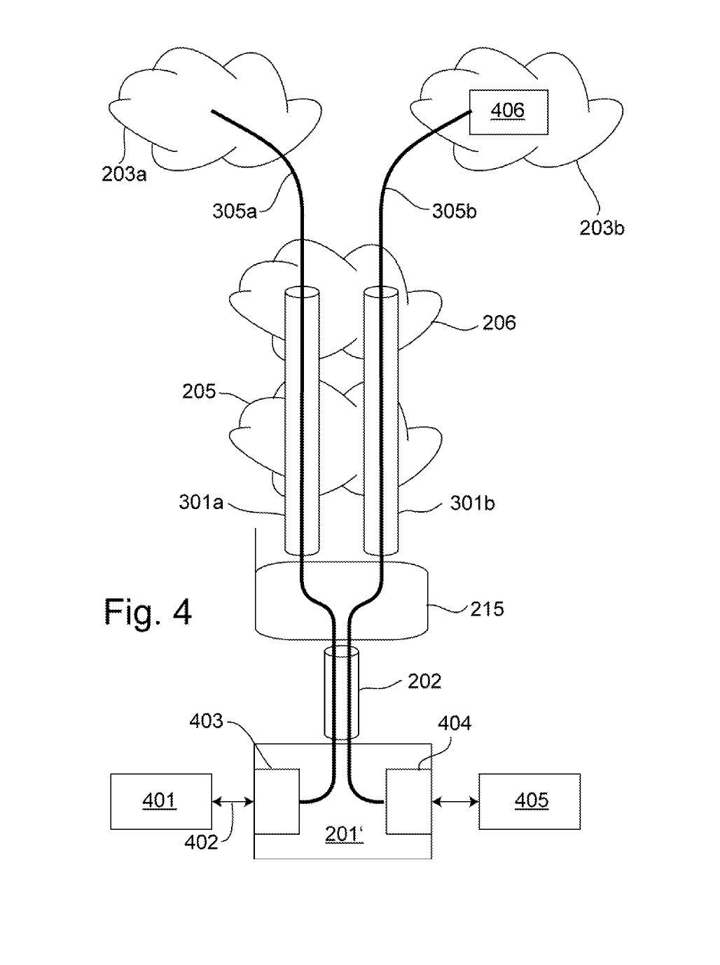

In one embodiment, which is schematically illustrated in FIG. 4, the terminal unit is a router device 201′ that allows a user to access several communication and data services. These services comprise a VoIP service as well as a data service for access to an external data network 203a which can particularly be the Internet.

The external data network 203a is accessed using another device, particularly an Internet-capable computer 401 of the user, that is connected to a routing module 403 of the router device 201′ via a local network connection 402. An end-to-end connection 305a between the router device 201′ and the external data network 203a is established in the mobile telecommunications network via a logical connection 301a. In order to access the VoIP service, the router device has an SIP client 404 (SIP: Session Initiation Protocol) that is connected to an additional device 405, for example, an SIP-capable or VoIP-capable telephone, of the user. The SIP client 404 communicates via an end-to-end connection 305b with a VoIP server 406 that is located in an external network configured as a provider network 203b. In the mobile telecommunications network, the end-to-end connection 305b is established via a logical connection 301b. Via the VoIP server 406, speech connections to communication partners can be established in the manner generally known to the person skilled in the art. In various embodiments, the provider network 203b is an IP Multimedia Subsystem (IMS) or a Next Generation Network (NGN) that is provided and operated by a telecommunications provider.

The router device 201′ is connected via the modem 215 to the mobile telecommunications network in the manner already described above. The modem 215 transfers the IP addresses that were issued when the logical connections 305a, 305b were established to the router device 201, which assigns the IP addresses to the routing module 403 and to the SIP client 404. Furthermore, the modem 215 associates a VLAN-ID with each of the logical connections 305a, 305b, and this VLAN-ID is likewise used in the manner already described above in order to transmit data packets via the local connection 307 between the modem 215 and the router device 201′. Preferably, the logical connection 305b is associated with a higher quality of service than the logical connection 305a. Accordingly, it is preferably provided that data packets belonging to the logical connection 305b are transmitted with a higher priority via the local connection 307 than the data packets belonging to the logical connection 305a.

Router devices 201′ of the type described above are fundamentally already known and are used to provide services via land-line networks, especially DSL-networks (DSL: Digital Subscriber Line) or VDSL-networks (VDSL: Very High Speed Digital Subscriber Line). Here, the router devices 201′ are connected by VLAN connections corresponding essentially to the VLAN connections in the embodiment described above to a network of a telecommunications provider. Via this network, connections are then established to additional external networks. As the preceding explanations show, such router devices 201′ can be connected to a mobile telecommunications network in a simple manner by using the modem 215, so that services offered in the land-line network can also be provided via the mobile telecommunications network. Here, only slight adaptations have to be made to the device software.

Although the subject innovation was described in detail in the drawings and in the presentation given above, the presentations are to be understood as illustrations and examples, and not to be construed in any limiting manner; in particular, the invention is not restricted to the embodiments shown.

In particular, the invention is not limited to the above-mentioned LTE/SAE networks. On the contrary, in an analogous manner, it can also be used in other mobile telecommunications networks in which end-to-end connections 305 are established into external networks 203 via logical connections 301 to gateway devices of the mobile telecommunications network whose establishment is associated with the assignment of an IP address. Thus, the invention can be used, for example, in GPRS-based mobile telecommunications networks (GPRS: General Packet Radio Service) in which the logical connection 301 is established as a so-called PDP context to a GGSN (Gateway GPRS Support Node) of the core network 206.

The person skilled in the art can glean other variants of the invention and their execution from the preceding disclosure, from the figures and from the patent claims.

Terms used in the patent claims such as “include”, “comprise”, “contain”, “have” and the like do not exclude additional elements or steps. The use of the indefinite article does not preclude a plurality. One individual device can execute the functions of several of the units or devices cited in the patent claims. The reference numerals indicated in the patent claims are not to be construed as limitations of the means and steps employed.

What is claimed is:

1. A method for providing at least one packet-oriented end-to-end connection from a terminal unit to another network via at least one connection in a mobile telecommunications network, a set-up of the connection including an assignment of an address for addressing data packets to the terminal unit, comprising:
transferring, via a modem that is connected to the mobile telecommunications network via an air interface, the address to the terminal unit; and
forwarding data packets of the end-to-end connection that have been received from the mobile telecommunications network to the terminal unit, the data packets being forwarded in an association with the connection.

2. The method recited in claim 1, comprising:
receiving data packets via the modem, the data packets being sent from the terminal unit in an association with the connection; and
forwarding the data packets via the connection.

3. The method recited in claim 1, comprising associating data packets with the connection using an identifier that is linked to the data packets and that is stored in the modem in an association with the connection.

4. The method recited in claim 1, wherein the data packets are transmitted in connection-specific data frames of a local connection between the modem and the terminal unit and the data frames are provided with the identifier.

5. The method recited in claim 1, comprising:
providing each one of multiple end-to-end connections via one connection in the mobile telecommunications network; and
associating an unambiguous identifier with each connection.

6. The method recited in claim 1, comprising:
establishing a first end-to-end connection for data transmission to a first additional network configured as a data network, particularly the Internet; and
establishing a second end-to-end connection for speech transmission to a voice over IP server in a second additional network.

7. The method recited in claim 1, comprising exchanging signaling messages between the modem and the terminal device via the local connection, using an associated identifier.

8. The method recited in claim 1, comprising:
exchanging signaling data for registering with the mobile telecommunications network or for establishing the connection, between the modem and the mobile telecommunications network; and
generating signaling messages sent to the mobile telecommunications network in the modem.

9. The method recited in claim 1, wherein the address is an IP address.

10. The method recited in claim 1, wherein the connection is a logical connection to a core network of the mobile telecommunications network.

11. The method recited in claim 10, wherein the connection comprises an EPS bearer.

12. The method recited in claim 1, wherein a local connection between the modem and the terminal unit is configured as an Ethernet connection.

13. A device for providing at least one packet-oriented end-to-end connection from a terminal unit to another network via at least one connection in a mobile telecommunications network, a set-up of the connection including an assignment of an address for addressing data packets to the terminal unit, the device comprising an air interface through which the device is connectable to the mobile telecommunications network, the device being configured to transfer the address to the terminal unit and to forward data packets of the end-to-end connection that have been received from the mobile telecommunications network to the terminal unit, the data packets being forwarded in an association with the connection.

14. A system, comprising:
a terminal unit; and
a device for providing at least one packet-oriented end-to-end connection from the terminal unit to another network via at least one connection in a mobile telecommunications network, a set-up of the connection including an assignment of an address for addressing data packets to the terminal unit, the device comprising an air interface through which the device is connectable to the mobile telecommunications network, the device being configured to transfer the address to the terminal unit and to forward data packets of the end-to-end connection that have been received from the mobile telecommunications network to the terminal unit, the data packets being forwarded in an association with the connection.

15. The system recited in claim 14, wherein a first end-to-end connection is established for data transmission from the terminal unit to a first additional network configured as a data network, particularly the Internet, and a second end-to-end connection is established for speech transmission from the terminal unit to a voice over IP server in a second additional network.

16. The system according to claim 15, wherein the terminal unit is connected to at least one user terminal device, the terminal unit being configured so that the user terminal device can access the first and/or the second end-to-end connection.
